(19) United States
(12) Patent Application Publication
(10) Pub. No.: US 2023/0311373 A1
(43) Pub. Date: Oct. 5, 2023

(54) DEVICE FOR THE FABRICATION OF TUBES WITH A NON-CIRCULAR SECTION ORIFICE GEOMETRY AND FABRICATION METHOD

(71) Applicant: AISAPACK HOLDING SA, Vouvry (CH)

(72) Inventor: Dominique FAVRE, Val-d'Illiez (CH)

(21) Appl. No.: 18/024,883

(22) PCT Filed: Jun. 8, 2021
(86) PCT No.: PCT/IB2021/055014

§ 371 Date: Mar. 6, 2023

(30) Foreign Application Priority Data
Sep. 7, 2020 (EP) 20194767.8

(51) Int. Cl. B29C 43/36; B29C 43/02

(52) U.S. Cl. CPC B29C 43/361; B29C 43/027; B29C 2043/3628; B29C 2043/029; B29L 2023/20

(57) ABSTRACT

The invention concerns in particular a device for moulding an article in which the article is obtained by compression moulding a dose (14) of material in the molten state and comprises at least one orifice (23) after the compression moulding operation, said device comprising at least one die (10), one mandrel (11) cooperating with said die (10) to effect the operation of compression moulding of the dose and one orifice rod (12) sliding in said die (10), said device further comprising a shape endpiece (13) placed between the mandrel (11) and the orifice rod (12) to form the orifice (23) of the article.

### CORRESPONDING APPLICATION

The present application claims priority to earlier European application No EP20194767.8 filed on Sep. 7, 2020 in the name of AISAPACK HOLDING SA, the entire content of this earlier application being incorporated by reference in the present application.

### TECHNICAL FIELD

The present invention concerns tubes the heads of which are produced by compression moulding, the moulding operation being also used to weld the tubular skirt to the tube head. The present invention enables the production of orifice geometries the section of which is not circular and applies in the packaging field and in particular in that of flexible tubes intended to contain creams or pastes such as toothpaste. The invention also concerns a method for producing that head and a tube with such a head.

### PRIOR ART

Tube heads produced by compression-moulding of a dose of resin in the molten state have been known for many years and described for example in the publication WO 2007/125481 the content of which is incorporated by reference in the present application. These tube heads are welded to the skirt of the tube conjointly with the compression moulding operation forming the head from a dose of material. In this method, the welding operation does not necessitate the application of heat other than that of the molten resin used to mould the tube head. The tube obtained by this method has advantageous aesthetic properties in the welding zone. In particular the transition between the skirt and the tube head forms a smooth and continuous surface. In this packaging the transition zone between the skirt of the tube and the tube head is not perceptible by the user, which represents a great benefit for the tubes used in the field of cosmetic products. However, with the known prior art devices it is not possible to produce non-circular section orifices in the tube head.

The invention in particular enables this drawback to be remedied.

Publication FR 2 846 594 discloses a method and a device for manufacturing plastic molded parts, in particular elements forming nozzles on packaging containers, preferably heads for packaging tubes.

### SUMMARY AND PRINCIPLE OF THE INVENTION

The invention relates in particular to means and methods for fabricating a tube the head of which is produced by compression moulding and the orifice of which serving to extract the product is of non-circular section and/or oriented and/or of complex section and/or comprises a plurality of orifices of different shapes. The means and methods in accordance with the invention also make it possible to optimize the distribution of the material and to prevent defects in the heads produced.

The invention also relates to a tube the geometry of the orifice of which is for example oriented relative to printing on the skirt or relative to the cap.

The invention also relates to a tube having a complex section orifice geometry or a plurality of orifices of different shapes.

The tube in accordance with the invention is characterized in particular by an upper face of the neck with a central surface and a peripheral surface, the orifice opening in the central surface and the two surfaces being offset relative to one another.

The invention also relates to a tube including a plurality of orifices.

The invention also relates to a method of carrying out the invention.

### REFERENCE NUMBERS AND BRIEF DESCRIPTION OF THE DRAWINGS

1: Tube
2: Tube head
3: Skirt
4: Orifice
5: Transition zone
6: External surface of the skirt 3
7:
8: fixing means (for example for a cap)
9: Peripheral surface
10: Die
11: Mandrel
12: Orifice rod
13: Shape endpiece
14:
15:
16:
17:
18:
19:
20: Tube
21: Tube head
22: Skirt
23, 23a, 23b, 23c, 23d: Orifice
24: Fixing means (for example screw thread)
25: Internal surface
26: Peripheral surface
27: Recess
28: Protrusion
29: Translation guide element
30: Pressurization element
31: Pressurization element
32: Rod exit abutment
33: Transition abutment
34: Rod-bush relative position abutment
35: Rod-bush relative position abutment
36: Bush-die alignment abutment
37: Bush
38: Bush-die alignment

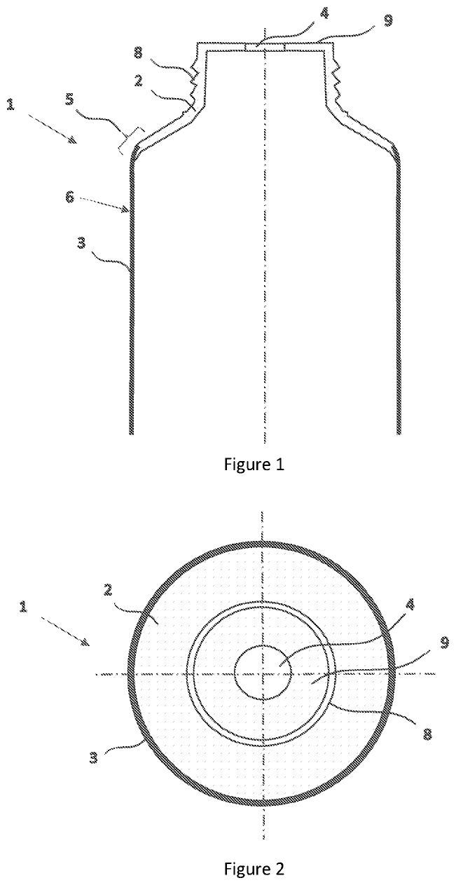

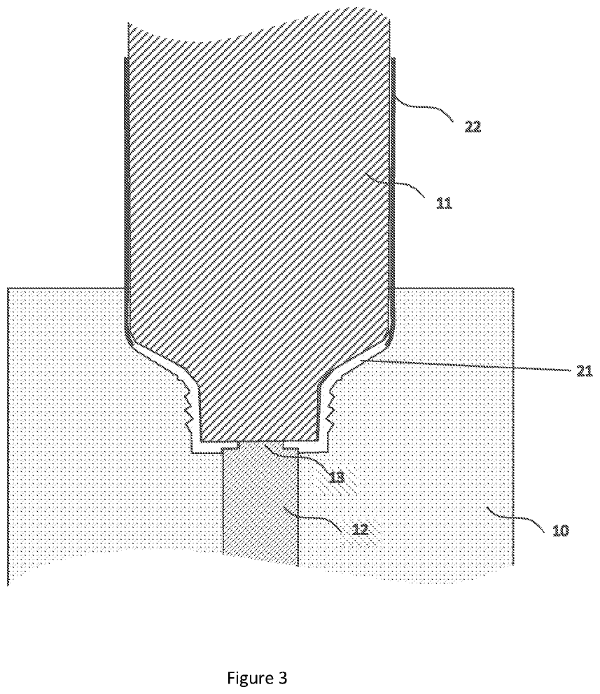

### Prior Art (FIGS. 1 and 2)

FIG. 1 illustrates a tube produced in accordance with the prior art. This tube 1 comprises a tube head 2, a skirt 3 overmoulded by compression moulding and a circular section orifice 4. The head further comprises fixing means for a cap, for example a screw thread 8, and a peripheral surface 9. The reference 5 indicates the transition zone between the head 2 and the skirt 3 that forms a smooth and continuous surface thanks to the compression moulding fabrication method.

FIG. 2 illustrates the prior art tube 1 in a view from above. In this representation the circular geometry of the orifice 4 corresponding to the prior art can be seen.

The means and the method for obtaining the tube from FIGS. 1 and 2 are described in the publication WO2007/125481 incorporated by reference in the present application, in particular in FIGS. 1 to 8 and the description of those figures.

### EMBODIMENTS OF THE INVENTION

FIGS. 3 to 6 and 18 illustrate in section embodiments of devices in accordance with the present invention for producing tube heads and tubes.

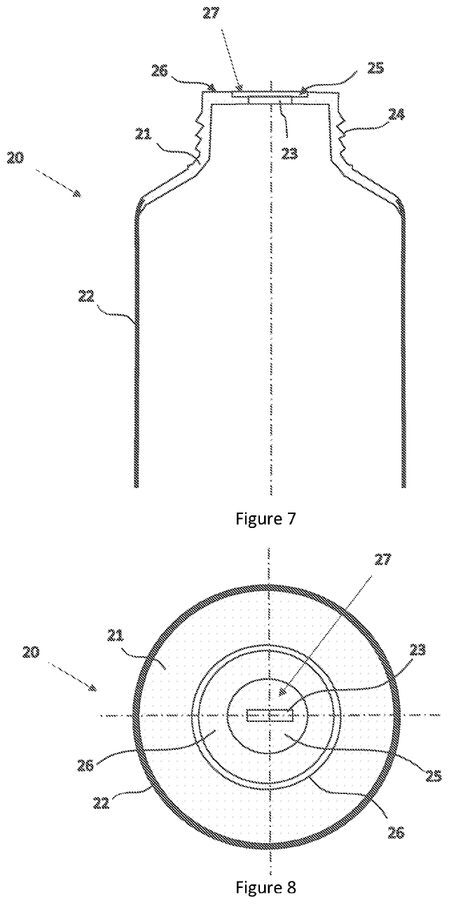

FIGS. 7 to 11 illustrate embodiments of heads and tubes and orifice geometries in accordance with the invention in section and in views from above.

FIG. 12 illustrates a feature of the tubes at the level of the transition zone between the tube head and the skirt.

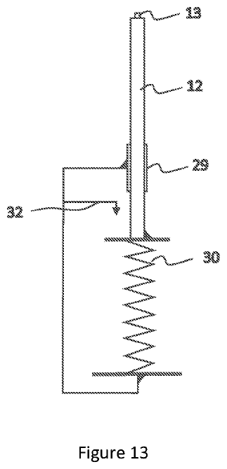

FIGS. 13 to 17 illustrate embodiments of means used in devices in accordance with the present invention.

In embodiments the invention concerns a device for moulding an article in which the article is obtained by compression moulding a dose of material in the molten state and comprises at least one orifice after the compression moulding operation, the device comprising at least one die, one mandrel cooperating with said die to effect the compression moulding operation of the dose and one orifice rod sliding in said die, the device further comprising a shape endpiece placed between the mandrel and the orifice rod to form the orifice of the article.

In embodiments of the invention the shape endpiece may be on the rod or on the mandrel or partly on the rod and partly on the mandrel.

In embodiments of the invention the device comprises at least one means for maintaining the mandrel and the orifice rod in contact via the shape endpiece.

In embodiments of the invention, the means may be a mechanical or pneumatic spring.

In embodiments of the invention, the device comprises a rod exit abutment for adjusting the amplitude of the axial movement of the rod.

In embodiments of the invention, the device comprises a second pressurization element for exerting a high pressure at the end of moulding, said second element being a short travel ram.

In embodiments of the invention, said device comprises a transition abutment for switching from the low pressure exerted by the first pressurization element to the high pressure exerted by the second pressurization element.

In embodiments of the invention, said device comprises a bush for centring the dose.

In embodiments the invention concerns a method for forming an article with an orifice from a dose of material in the molten state, said method using a die cooperating with a mandrel, an orifice rod and a shape endpiece placed between the mandrel and the orifice rod, the article being formed by compression moulding the dose between the die and the mandrel and the orifice of the article being created by the shape endpiece surrounded by material during the compression moulding operation.

In embodiments of the invention, a first pressurization means is used to bring into contact the shape endpiece, the mandrel and the orifice rod during the closing of the mould and a second pressurization means is used to exert a high pressure at the end of moulding.

In embodiments of the invention, a transition abutment is used to switch from the pressure exerted by the first pressurization means to the pressure exerted by the second pressurization means.

In embodiments the invention concerns an article comprising at least one central surface, one peripheral surface and one orifice formed by a shape endpiece, the orifice opening in the central surface and said central and peripheral surfaces being offset relative to one another.

In embodiments of the invention, the offset between the surfaces forms a recess or a protrusion.

In embodiments of the invention, said orifice comprises at least two distinct orifices having the same geometry or a different geometry.

In embodiments of the invention, the article may be a tube head or a tube.

### DETAILED DESCRIPTION

FIG. 1 illustrates a tube produced in accordance with the prior art. This tube 1 comprises at least one tube head 2, one skirt 3 overmoulded by compression moulding and one orifice 4 of circular section. The tube head 2 is fabricated by compression moulding a dose of plastic material in the molten state. The skirt 3 is assembled to the tube head 2 during the moulding of the head by a so-called overmoulding operation consisting in positioning the skirt in the mould and using the heat of the moulded plastic material to effect the assembly between the tube head 2 and the skirt 3. The prior art tubes produced in accordance with this method have the advantage of having a perfect transition zone 5 between the skirt 3 and the tube head 2. For this reason the tubes are often used in the cosmetic field where the aesthetic criteria of the packaging are of prime importance.

FIG. 2 illustrates the prior art tube 1 in a view from above. There is seen in particular the geometry of the orifice 4 that forms a circular section opening. This orifice 4 is used to extract the product from the packaging.

It is nevertheless required in some cases to fabricate tubes having a head the orifice of which has a different section, that is to say in particular a non-circular section, and for example having any shape or indeed including a plurality of orifices of any shape, either for reasons of practicality or for reasons of marketing or for other reasons, for example stemming from the product contained in the tube and/or its use. The device known from WO2007/125481 not allowing any such freedom, it is modified in accordance with the invention as described hereinafter.

An object of the present invention is therefore to improve the known products and methods.

To be more precise, one object of the present invention is to propose means enabling production by compression moulding of a container in the form of a tube having an orifice of any shape.

Another object of the present invention is to propose a simple and reliable solution that can easily be fitted to machines currently in service. It is therefore necessary to avoid a solution and means that are radically different but rather to propose means that are easily applicable to existing machines.

Thus, FIG. 3 illustrates one embodiment of a device in accordance with the invention for producing a tube head or a tube in accordance with the invention in which the section of the orifice is not circular. This device comprises a mould comprising at least one die 10, one mandrel 11, one orifice rod 12 and a shape endpiece 13. The orifice rod 12 slides in the die 10 and includes said shape endpiece 13 at its end.

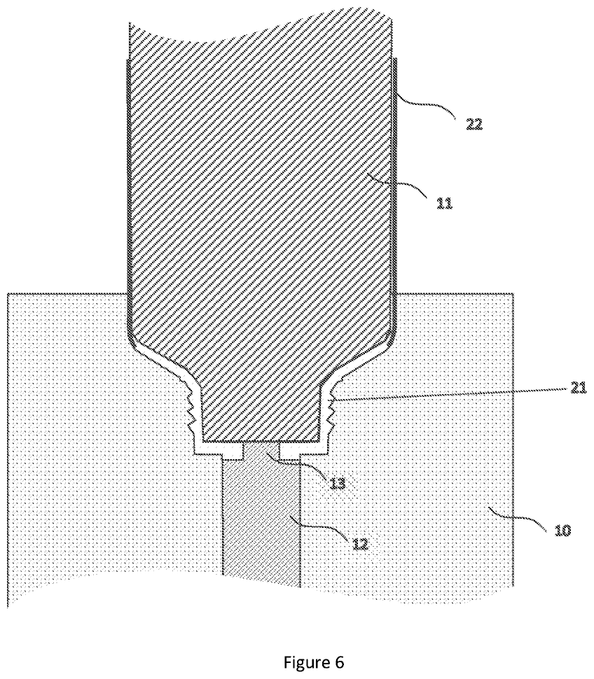

During the formation of the tube (in the operation of compression moulding the head 2 on the skirt 3, see for example FIGS. 6 and 7 of WO2007/125481) in accordance with the present invention the shape endpiece 13 is maintained in contact with the mandrel 11 and is driven by the relative movement between the die 10 and the mandrel 11 during the compression moulding operation.

To be more precise, the orifice rod 12 no longer has a continuous shape (in section) as in WO2007/125481 but comprises at its end in contact with the mandrel 11 a shape endpiece 13 that is used to create the geometry of the orifice 23 of the tube. With this construction it is possible to create any shape of orifice 23 of the tube (or of the tube head), without significant modification of the rod 12. The endpiece 13 may be formed directly in the material of the rod or be an attached part (for example screwed on, welded on or stuck on, etc.). The material may be the same or a different material.

A force is exerted on the rod 12 to maintain the contact between the shape endpiece 13 and the mandrel 11 during the moulding operation and to prevent the molten material entering between the mandrel 11 and the endpiece 13.

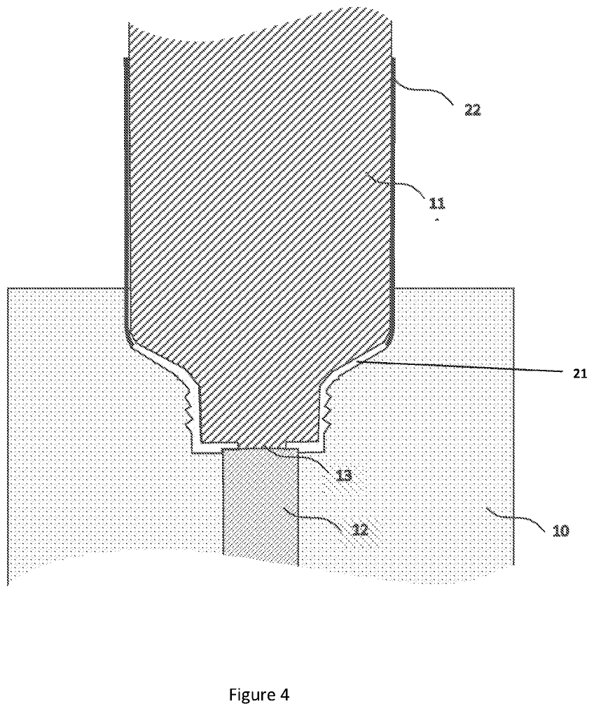

FIG. 4 illustrates another embodiment in which the shape endpiece 13 is fixed to the mandrel 11 (such as for example an attached part fixed by gluing, welding or screwing, etc.) or forms part of the mandrel 11. The principle is the same as that described with reference to FIG. 3.

In variants, the shape endpiece 13 may be in several parts, for example in two (or more) parts, at least one of which is on the mandrel 11 and the other on the rod 12.

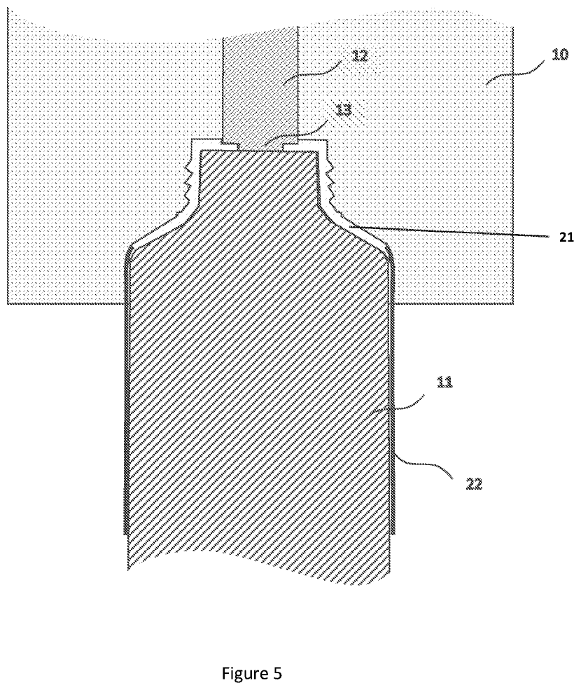

FIG. 5 illustrates an embodiment of a device in which the dose of plastic material is deposited on the mandrel 11. The operating principle is the same as in FIG. 3 or 4, the device simply being turned through 180°, the mandrel 11 being at the bottom and the die 10 at the top. The shape endpiece 13 may be placed on the mandrel 11 or on the rod 12 or in part on one of them and in part on the other of them.

FIG. 6 illustrates the device from FIG. 3 but in another configuration: in this FIG. 6 the length of the shape endpiece 13 along the axis of the rod 12 is greater than the intended thickness of the tube head at the level of the peripheral surface 26 so that the shape of the tube head will be different, as explained below.

FIGS. 7 and 8 illustrate a tube 20 in accordance with one embodiment of the invention obtained for example using the device illustrated in FIGS. 3 to 5. This tube 20 has an orifice 23 with a rectangular section geometry (see FIG. 8), which is advantageous for delivering a product with a small thickness for example. The tube 20 in accordance with the invention has on the one hand the advantage of the quality of the transition zone between the skirt 22 and the tube head 21 that forms a continuous surface with no asperity stemming from the compression moulding method used and described hereinabove and on the other hand the advantage of having a complex non-circular section orifice geometry better suited to the extraction of the product in the intended application. Generally speaking, the shape endpiece 13 therefore has a shape corresponding to that of the orifice 23 in such a manner as to form that geometry during the compression moulding process.

In accordance with this embodiment of a tube in accordance with the invention illustrated in FIGS. 7 and 8 the front face of the neck of the tube head 21 comprises a central surface 25 and a peripheral surface 26 that are offset relative to one another. As can be seen in FIGS. 7 and 8 the orifice 23 opens in the central part of the neck at the level of the central surface 25 in a recess 27 formed by the relative offset of the surfaces 25 and 26.

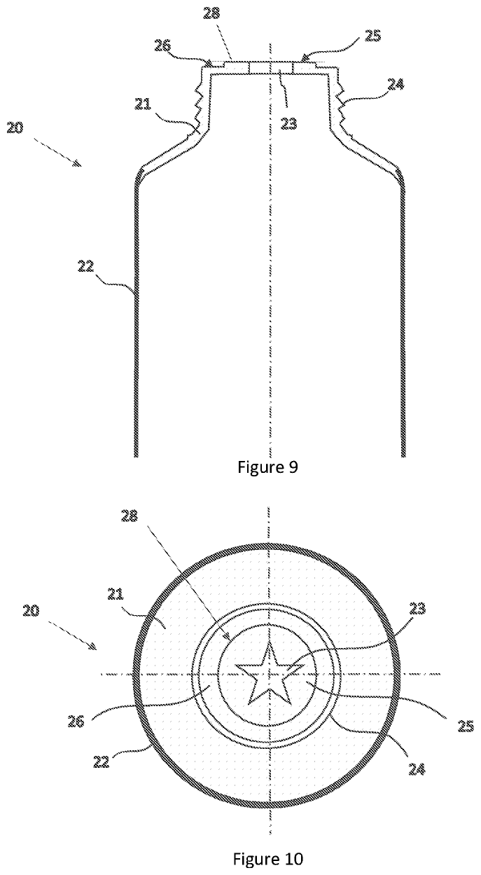

FIGS. 9 and 10 illustrate another embodiment of a tube in accordance with the invention obtained for example using the device illustrated in FIG. 6. In this embodiment the tube 1 has a shar-shaped geometry of the orifice 23 that can be used for marketing reasons for example.

In accordance with this embodiment illustrated in FIGS. 9 and 10 the front face of the neck of the tube head 21 comprises a central surface 25 and a peripheral surface 26 that are offset relative to one another but in the opposite direction to that in FIGS. 3 and 4. The orifice 4 opens in the central part of the neck at the level of the central surface 25 on a protrusion 28 formed by the offset of the surfaces 25 and 26. The formation of a recess 27 or of a protrusion 28 is produced by the length of the endpiece 13 relative to the intended thickness of the shoulder at the level of the peripheral surface 26: as in FIG. 7 to produce a recess 27 or as in FIG. 9 to produce a protrusion 28.

In fact, as the rod 12 and the mandrel 11 are always in the same position pressed one against the other, it is possible to form a recess 27 or a protrusion 28 exclusively by adjusting the length of the endpiece 13 relative to the thickness of the shoulder.

In accordance with embodiments of the invention, when the offset between the surfaces 25 and 26 forms a recess 27 (for example as illustrated in FIG. 7) the value of the offset between the surfaces 25 and 26 is less than 5 mm and preferably less than 0.5 mm.

In accordance with embodiments of the invention, when the offset between the surfaces 7 and 9 forms a protrusion 28 (for example as illustrated in FIG. 9) the value of the offset between the surfaces 25 and 26 is less than 10 mm and preferably less than 0.5 mm.

In accordance with embodiments of the invention the offset between the surfaces 25 and 26 is close to zero. In these embodiments the value of the offset is less than 0.4 mm in both directions (“recess” and “protrusion”) and preferably less than 0.2 mm.

The tubes obtained in accordance with the invention are characterized in particular by the fact that the thickness of the wall of the tube measured at the level of the central surface 7 over a large number of tubes from the same production run varies very little whereas the thickness measured at the level of the peripheral surface on the same samples varies more.

In accordance with the invention it proves that the thickness measured at the level of the central surface 7 does not depend on variations in the weight of the dose of resin used to mould the tube head whereas the variation of the thickness of the wall at the level of the surface 9 does depend on variations in the weight of the dose.

Consequently, either the mould is designed so that the tube head includes a protrusion 28 with small variations that depend on the variation in the weight of the dose as illustrated in FIG. 9 and with a device as illustrated in FIG. 6 or the mould is designed so that the tube head includes a recess 27 with small variations that depend on the variations in the weight of the dose as illustrated in FIG. 7 and with the device in the configuration from FIG. 3.

Thus the present invention enables variations in the quantity of material in the dose to be circumvented and to be compensated directly during the compression moulding method in accordance with the invention to produce a product without defects.

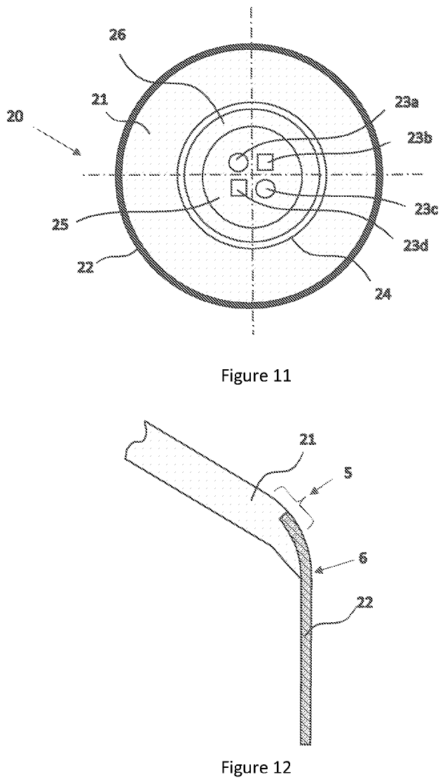

FIG. 11 illustrates another embodiment of the invention. In this embodiment the tube 20 includes a multiplicity of orifices 23a, 23b, 23c and 23d. In this embodiment the orifices 23a and 23c have a circular section geometry and the orifices 23b and 23d have a square section geometry. Other configurations may of course be envisaged both with regard to the number of orifices and with regard to their shape or their size. These orifices are formed by the shape endpiece 13 that may be on the rod 13, on the mandrel 11 or on both. For example, it may be envisaged that the endpiece forming the orifices of one geometry is on one of the rod or the mandrel and that the endpiece forming the orifices with a different geometry are on the other of the rod and the mandrel. Of course, other configurations are possible as a function of circumstances, required shapes, etc.

Any shape may be given to the orifice using the principles of the present invention as described in the present application and the invention is not limited to those illustrated by way of non-limiting example.

FIG. 12 illustrates a feature of the tubes 21 produced in accordance with the invention that is also a feature of the prior art tubes in which the head is moulded by compression moulding. These tubes 21 have a transition zone 5 of high quality between the skirt 3 and the head 2. These tubes 21 are characterized by the fact that the external surface 6 is perfectly continuous and without asperities in the zone 5, which is a preferred feature in the context of the present invention for the reasons explained hereinabove.

The tubes may be of circular or oval or elliptical section, for example, or oblong, or square, and the principles of the present invention apply to all tube shapes.

The devices described and illustrated have been simplified to clarify the description. These devices are not represented but are known in principle in the prior art and comprise in particular mould extraction means, opening and closing means, means for cooling the compression moulding means, means for loading and retaining the skirt of the tube, and means for receiving and guiding the dose of plastic material.

FIGS. 13 to 17 illustrate embodiments of the means used to implement the device and the method in accordance with the invention. In these examples and for simplicity only the functional parts linked to the invention are represented.

FIG. 13 illustrates a first embodiment of the means used to carry out the invention. In this embodiment the device includes in particular means that enable the mandrel 11 and the orifice rod 12 to be maintained in contact during the compression moulding operation via the shape endpiece 13. In particular such means are preferably employed to prevent moulded material being inserted between the shape endpiece 13 and the mandrel 11. A first embodiment illustrated in FIG. 13 comprises a passive element such as a mechanical or pneumatic spring 30 to exercise this function. An alternative that is not represented may use an active element such as a preferably pressure-controlled ram. This solution enables adjustment of the axial force on the orifice rod 12 as a function of the forces employed during moulding. As FIG. 13 illustrates, the device also comprises guide means 29 that allow the axial movement of the orifice rod 12 and a rod exit abutment 32 that enables adjustment of the amplitude of the axial movement of the rod 12. In the case where the element 30 is a ram, an end of travel sensor is advantageously used as an end of travel abutment. The device illustrated in FIG. 13 is advantageously used in the moulding configuration illustrated in FIG. 5 in which a dose is deposited on the mandrel.

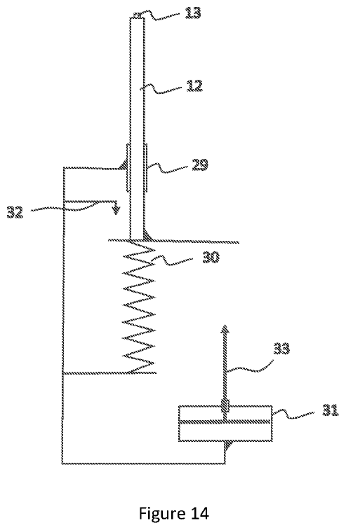

The embodiment illustrated in FIG. 14 comprises at least one first pressurization element 30 and one second pressurization element 31. This embodiment is advantageously used when the orifice rod 12 has a long axial stroke. This is the case when the orifice rod 12 is used to centre the dose in the cavity 10 during the dosing phase. The first pressurization element 30 enables the shape endpiece 13 and the mandrel 11 to be brought into contact during the closing of the mould. The second pressurization element 31 enables a high pressure to be exerted at the end of moulding in order to prevent the moulded resin from being inserted between the mandrel 11 and the shape endpiece 13. As the pressure at the end of moulding is high it is necessary to exert a sufficient pressure to prevent blocking the orifice 23 of the packaging. The first pressurization element 30 may be a passive element such as a mechanical or pneumatic spring as illustrated in FIG. 14. Alternatively, this element may be controlled actively, like a ram. The second pressurization element 31 is advantageously a short stroke piston as illustrated in FIG. 14. A ram of this kind allows easy adjustment of the pressure retaining the orifice rod 12 as a function of the moulding pressure. Alternatively, this element 31 may be a passive spring of high stiffness. The device illustrated in FIG. 14 also comprises a rod exit abutment 32 that limits the exit stroke of the orifice rod 12 and a transition abutment 33 that enables switching from the low pressure exerted by the first pressurization element 30 to the high pressure exerted by the second pressurization element 31. In accordance with the embodiment illustrated in FIG. 14, the first pressurization element 30 is disposed in parallel with the second pressurization element 31.

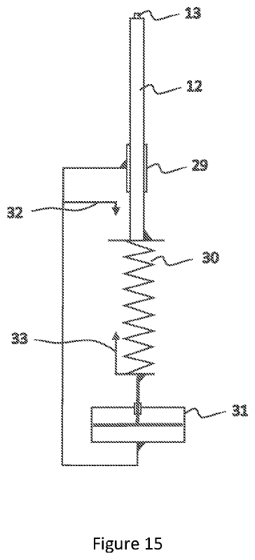

FIG. 15 illustrates an embodiment similar to that from FIG. 14 but in which the first pressurization element 30 is disposed in series with the second pressurization element 31.

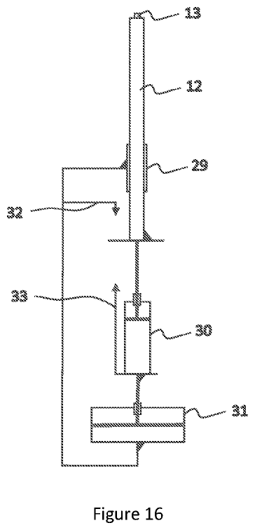

FIG. 16 illustrates an embodiment similar to that from FIG. 15 but in which the first pressurization element 30 and the second pressurization element 31 are rams the pressure of which can be adjusted. FIG. 16 illustrates an embodiment in which the first pressurization element 30 and the second pressurization element 31 are in series. Another embodiment (not illustrated) may be produced in which the pressurization rams 30 and 31 are disposed in parallel.

The embodiments illustrated in FIGS. 14, 15 and 16 are advantageously associated with the moulding configurations illustrated in FIGS. 3, 4 and 6 in which the orifice rod is also used to centre the dose during the dosing operation.

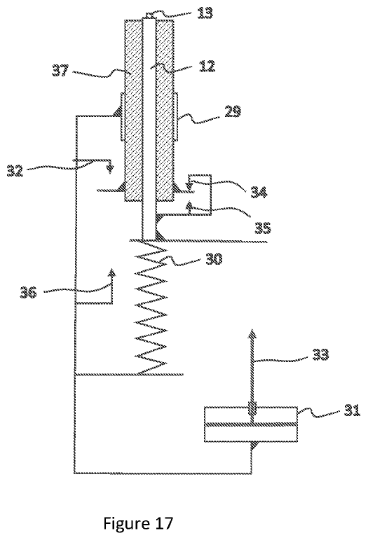

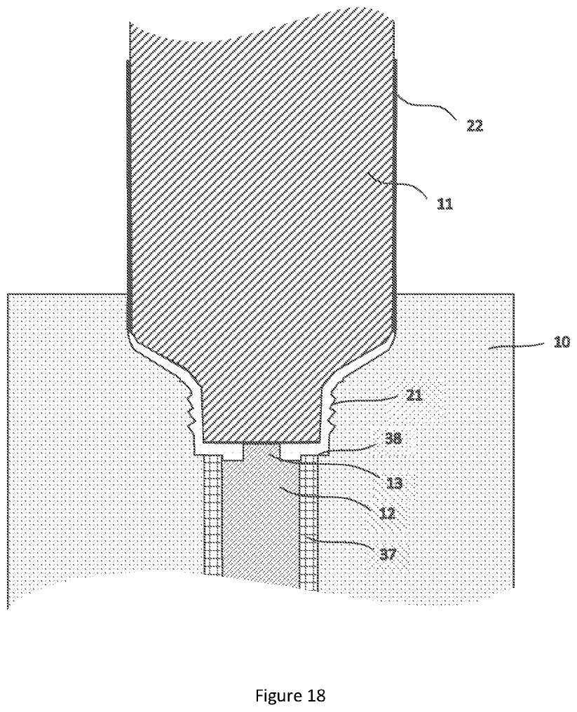

The embodiment illustrated in FIG. 17 is similar to that illustrated in FIG. 14 but further comprises a bush 37 used to centre the dose during the dosing operation. The utilization of such a bush 37 is advantageous when the inside diameter of the dose (which is generally in the shape of a torus) is large compared to the diameter of the orifice rod. The dosing bush is aligned with the cavity of the mould as illustrated in FIG. 18. The bush-die alignment abutment 36 enables this function to be provided. The rod-bush relative position abutments 34 define the maximum relative movement between the orifice rod 32 and the bush 37. In accordance with the embodiment illustrated in FIG. 17, the pressurization elements 30 and 31 are disposed in parallel. A similar device (not illustrated) in which the pressurization elements 30 and 31 are in series may also be used.

FIG. 18 illustrates the moulding configuration corresponding to the device illustrated in FIG. 17. At the end of moulding the axial position of the bush 37 is defined by the bush-die alignment at 38 that enables a head surface to be obtained with no shoulder at the junction of the die 10 and the bush 37.

In FIGS. 3 to 6, 7, 9 and 18 there have respectively been represented a device for forming a tube head and a tube (that is to say a tube head 21 attached to a skirt 22) but it is obvious that the principle of the present invention applies to the manufacture of a tube head 21 alone without the skirt and the present invention also covers this aspect of the manufacture of a tube head by compression moulding. The representation of the skirt is therefore a non-limiting embodiment.

The embodiments described are described by way of illustrative examples and must not be considered as limiting on the invention. Other embodiments may call upon means equivalent to those described for example. The embodiments may equally be combined with one another as a function of circumstances or means used in one embodiment may be used in another embodiment.

1. Device for moulding an article in which the article is obtained by compression moulding a dose of material in the molten state and comprises at least one orifice after the compression moulding operation, said device comprising at least one die, one mandrel cooperating with said die to effect the operation of compression moulding of the dose and one orifice rod sliding in said die, said device further comprising a shape endpiece placed between the mandrel and the orifice rod to form the orifice of the article.

2. Device according to claim 1, in which the shape endpiece is on the rod or on the mandrel or partly on the rod and partly on the mandrel.

3. Device according to claim 1, said device comprising at least one means for maintaining the mandrel and the orifice rod in contact via the shape endpiece.

4. Device according to claim 3 in which the means is a mechanical or pneumatic spring.

5. Device according to claim 1, said device comprising a rod exit abutment for adjusting the amplitude of the axial movement of the rod.

6. Device according to claim 1, said device comprising a second pressurization element for exerting a high pressure at the end of moulding, said second element being a short travel ram.

7. Device according to claim 6, said device comprising a transition abutment for switching from the low pressure exerted by the first pressurization element to the high pressure exerted by the second pressurization element.

8. Device according to claim 1, said device comprising a bush for centring the dose.

9. Method of formation of an article with an orifice from a dose of material in the molten state, said method using a die cooperating with a mandrel, an orifice rod and a shape endpiece placed between the mandrel and the orifice rod, the article being formed by compression moulding the dose between the die and the mandrel and the orifice of the article being created by the shape endpiece surrounded by material during the compression moulding operation.

10. Method according to claim 9, in which a first pressurization means is used to bring into contact the shape endpiece, the mandrel and the orifice rod during the closing of the mould and a second pressurization means is used to exert a high pressure at the end of moulding.

11. Method according to claim 9, in which a transition abutment is used to switch from the pressure exerted by the first pressurization means to the pressure exerted by the second pressurization means.

12. Article comprising at least one central surface, one peripheral surface and one orifice formed by a shape endpiece, said orifice opening in the central surface and said central and peripheral surfaces being offset relative to one another.

13. Article according to claim 12, said offset between said surfaces forming a recess or a protrusion.

14. Article according to claim 12, said orifice comprising at least two distinct orifices having the same geometry or a different geometry.

15. Article according to claim 12, said article being a tube head or a tube.
